(19) United States
(12) Patent Application Publication
(10) Pub. No.: US 2010/0122204 A1
(43) Pub. Date: May 13, 2010

(54) AUTOMATIC DISPLAY OF SYMMETRIC ANATOMICAL STRUCTURE

(75) Inventor: Jeroen Sonnemans, Eindhoven (NL)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/598,434

(22) PCT Filed: Apr. 24, 2008
(86) PCT No.: PCT/IB2008/051575

§ 371 Date: Nov. 2, 2009

(30) Foreign Application Priority Data
May 4, 2007 (EP) 07107492.6

(51) Int. Cl. G06F 3/00

(52) U.S. Cl. 715/782; 715/800

(57) ABSTRACT

The invention relates to a method for displaying within a display area a symmetric anatomical structure the method comprising automatically calculating a zoom-factor for the symmetric anatomical structure based upon the display area; automatically calculating a panning position for the symmetric anatomical structure based upon the display area; displaying the symmetrical anatomical structure according to the calculated zoom-factor and panning position within the display area. The invention also relates to a system, a medical imaging workstation comprising the system and a computer program product designed to perform the method according to the invention.

The invention relates to method for displaying within a display area a symmetric anatomical structure.

The invention further relates to a system for displaying within a display area a symmetric anatomical structure.

The invention further relates to a medical imaging workstation comprising such a system.

The invention further relates to a computer program product to be loaded by a computer arrangement, comprising instructions for displaying a symmetric anatomical structure within a display area.

An embodiment of such a method and system is known from article M. P. Revel, D. Petrover, A. Hernigou, C. Lefort, G. Meyer, G. Frija, Diagnosing Pulmonary Embolism with Four-Detector Row Helical CT: Prospective Evaluation of 216 Outpatients and Inpatients, Radiology, 234: 265-273, 2005. This article discloses analysis of the lung parenchyma and vasculature in Computed Tomography (CT) image data sets. For visualization, a user must select the Field of View (FOV) for each parenchyma separately through panning and zooming interactions with the images. This must be performed for each slice within the stack of image slices of which the image data set consists. The FOV must also be selected manually when a user, such as a radiologist, wants to view both parenchyma at the same time within one view.

The lung parenchyma are an example of a symmetric anatomical structure within the human body. Other examples are: the legs and its vessel structure, for example visualized through a Magnetic Resonance (MR) peripheral angiography study. Yet another example is the head and its vessel structure, for example visualized through an MR carotid angiography study or the female breasts for example visualized through a Maximum Intensity Projection (MIP) of an MR breast study.

Determining a correct FOV is important for a radiologist who is interested in seeing high detail in the area of interest for determining a diagnosis. Consequently, a correct FOV may decrease reading time per study of a radiologist and thus supports the workflow within a medical care facility.

It is an object of the invention to provide a method, system, medical imaging workstation and computer program product according to the opening paragraph that determines a FOV in an improved way. To achieve this object, the method for displaying within a display area a symmetric anatomical structure, comprises automatically calculating a zoom-factor for the symmetric anatomical structure based upon the display area; automatically calculating a panning position for the symmetric anatomical structure based upon the display area; displaying the symmetrical anatomical structure according to the calculated zoom-factor and panning position within the display area. By automatically calculating a FOV based upon the zoom-factor and the panning position, a symmetrical anatomical structure is displayed without requiring user interaction. In this way, a radiologist can study the anatomical structure with the required detail in the area of interest. As the radiologist does not have to perform zooming and panning manually to determine the FOV, the reading time per symmetrical anatomical structure decreases. Consequently, the workflow of the radiologist is improved.

In an embodiment of the method according to the invention, the symmetric anatomical structure is comprised within a 3D volumetric dataset comprising a stack of slices and the method comprises automatically calculating the zoom-factor and the panning position for each slice of the stack of slices. By automatically calculating the FOV per slice, a user can navigate quickly through the stack of slices and study each slice with the required detail in the area of interest. The user interaction is minimal because there's no need for manually adjusting the FOV per slice thereby reducing the reading time per volumetric dataset and improving the workflow of a user such as a radiologist.

In a further embodiment of the method according to the invention, the symmetric anatomical structure comprises at least two sub-structures that are substantially symmetrical to each other and the method comprises: automatically calculating the zoom-factor and the panning position for each at least two sub-structures separately; and displaying the at least two sub-structures separately according to their respective calculated zoom-factor and panning position. Sub-structures are for example the two parenchyma of a lung or the two breasts of a female breast. By automatically calculating the FOV per sub-structure a user can easily navigate between different views of the same symmetrical anatomical structure. The FOV does not need to be determined manually per sub-structure which improves the workflow further.

In a further embodiment of the method according to the invention, the zoom-factor and the panning position are calculated during import of the symmetric anatomical structure within a database. By calculating the FOV during import of the structure, the structure is displayed faster. This improves the reading time per study even further.

In a further embodiment of the method according to the invention, displaying the symmetric anatomical structure and/or sub-structures is automatically invoked through a user interface. By providing a dedicated user interface for displaying the structure with the automatically calculated FOV, the user is in control when to display the FOV and which structure to display with this FOV, i.e. the whole structure or the sub-structures.

To further achieve the object, the system for displaying within a display area a symmetric anatomical structure, comprises: a calculator for automatically calculating a zoom-factor for the symmetric anatomical structure based upon the display area; and for automatically calculating a panning position for the symmetric anatomical structure based upon the display area; a displayer for displaying the symmetrical anatomical structure according to the calculated zoom-factor and panning position within the display area.

Embodiments of the system according to the invention are described in claims 7 to 10.

To further achieve the object, the medical imaging workstation comprises the system according to any of the claims 6 to 10.

To further achieve the object, the computer program product to be loaded by a computer arrangement, comprising instructions for displaying a symmetric anatomical structure within a display area, the computer arrangement comprising processing unit and a memory, the computer program product, after being loaded, providing said processing unit with the capability to carry out the following tasks: automatically calculating a zoom-factor for the symmetric anatomical structure based upon the display area; automatically calculating a panning position for the symmetric anatomical structure based upon the display area; displaying the symmetrical anatomical structure according to the calculated zoom-factor and panning position within the display area.

The same advantages are achieved with the system, the medical imaging workstation and the computer program product according to the invention as were described with respect to the method according to the invention.

These and other aspects of the invention will be apparent from and elucidated with reference to the embodiments described hereinafter as illustrated by the following Figures:

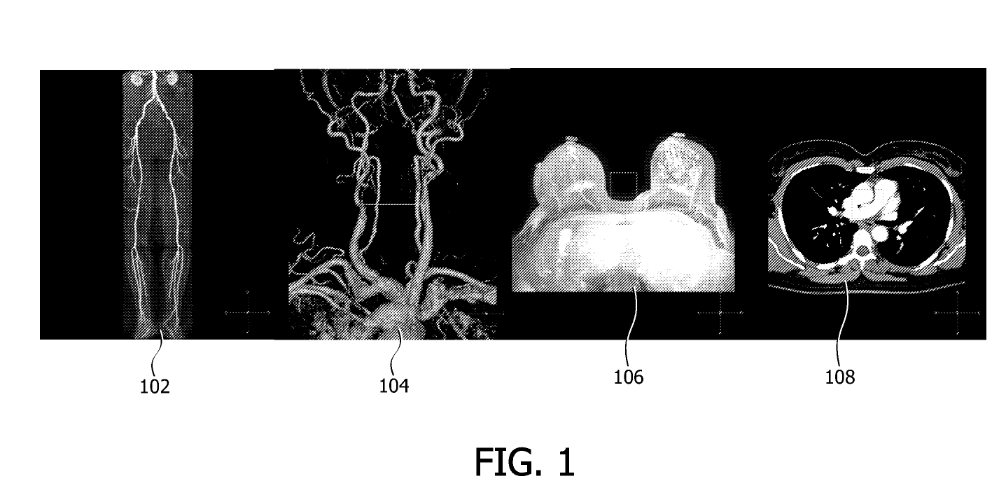

FIG. 1 illustrates examples of symmetrical structures;

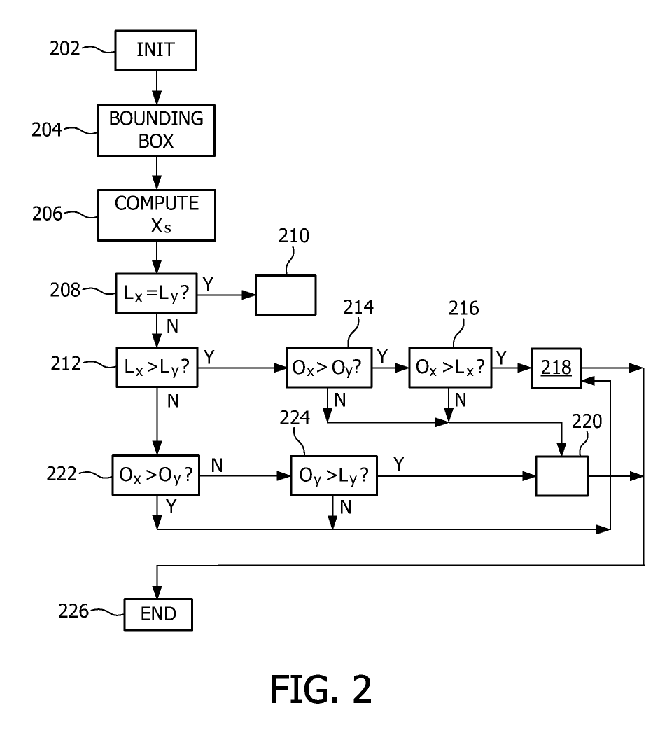

FIG. 2 illustrates the method according to the invention in a schematic way;

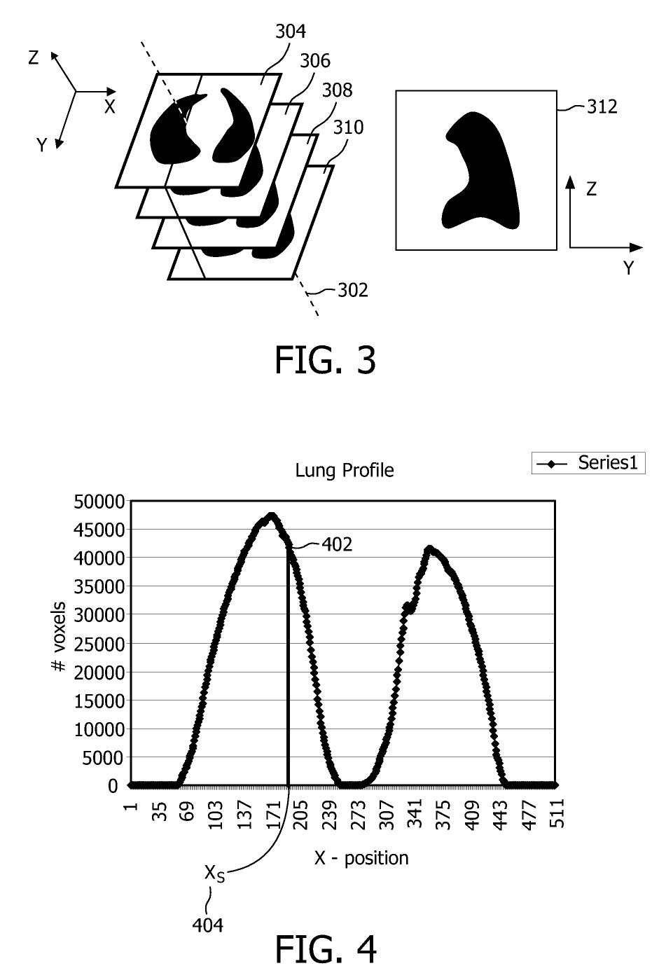

FIG. 3 illustrates segmented lung parenchyma as a stack of 2 D slices in a schematic way;

FIG. 4 illustrates a histogram of the number of segmented voxels as a function of the x-position in a binary volumetric dataset;

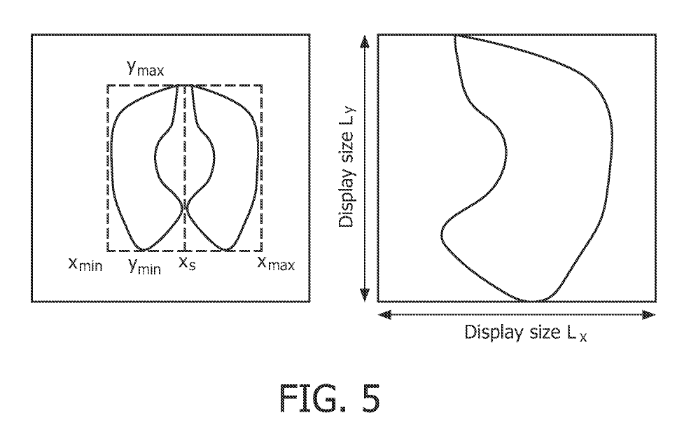

FIG. 5 illustrates a translation from computed object parameters to pan and zoom parameters;

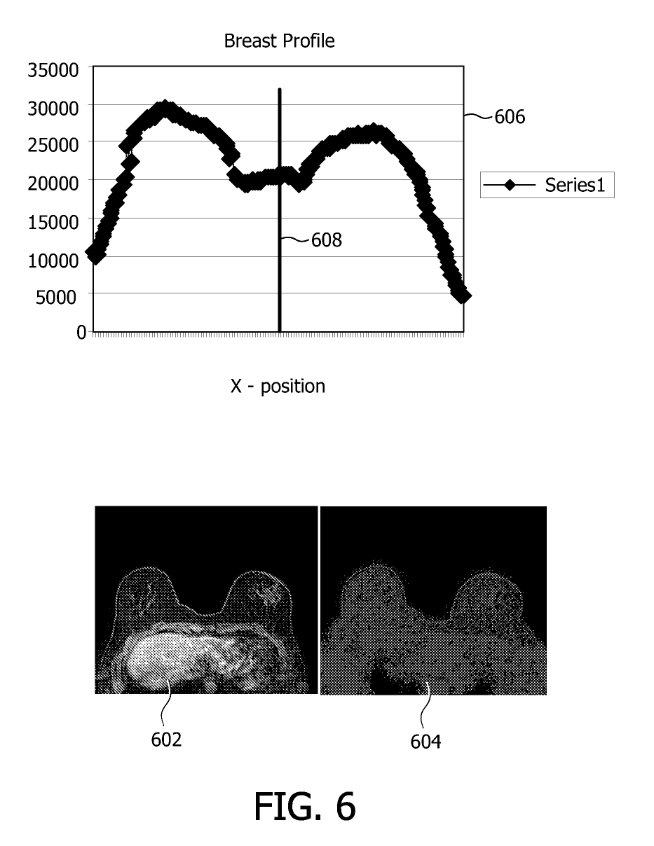

FIG. 6 illustrates a histogram for an MR breast study;

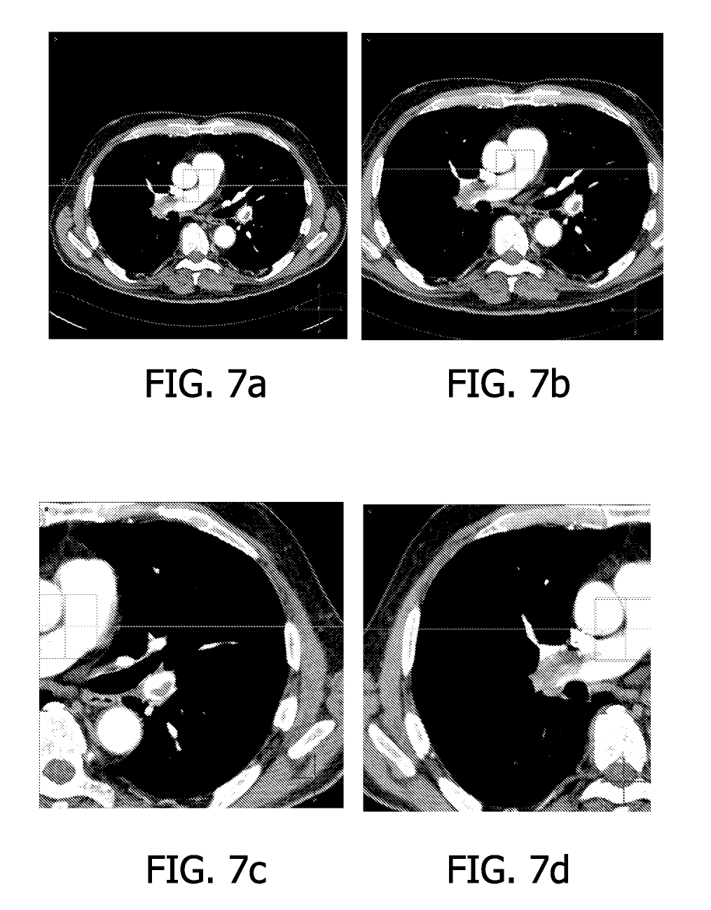

FIG. 7a illustrates an example of a received data set;

FIG. 7b illustrates the FOV optimized for both lungs;

FIG. 7c illustrates the FOV optimized for the right lung;

FIG. 7d illustrates the FOV optimized for the left lung;

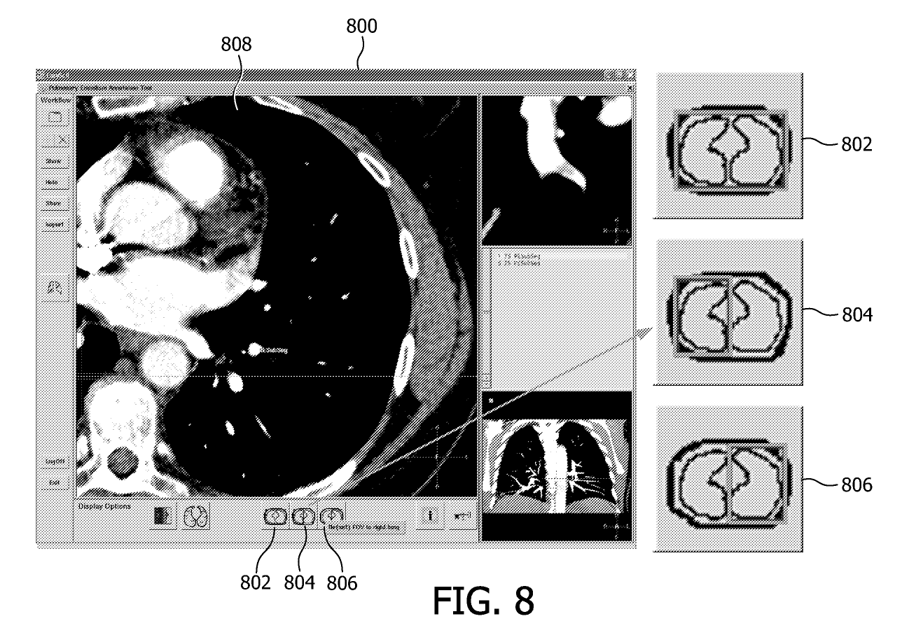

FIG. 8 illustrates a user interface for invoking the method according to the invention;

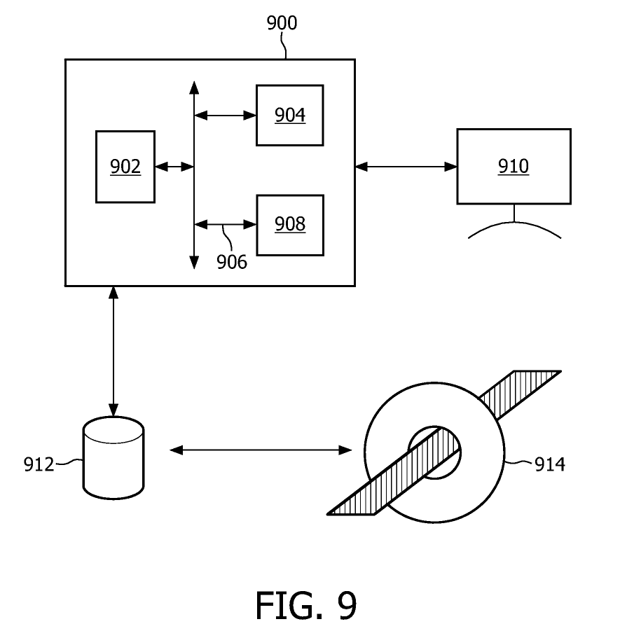

FIG. 9 illustrates a system according to the invention in a schematic way.

FIG. 1 illustrates examples of symmetrical structures. The first symmetrical structure 102 are the leg arteries which can be visualized by a Maximum Intensity Projection (MIP) of a Magnetic Resonance (MR) angiography study. The second symmetrical structure 104 are the carotid arteries which can be visualized by an SVR (Shaded Volume Rendering) of an MR carotid angiography study. The third symmetrical structure 106 are the female breasts which can be visualized by a MIP of a MR breast study. The fourth structure 108 are the lungs which can be visualized by a Computed Tomography (CT) thorax study. The invention can be applied to these examples of symmetric structures. However, the invention can also be applied to other symmetric structures within the body that are visualized by obtaining images of the symmetric structure through a medical acquisition device, such as an MR-imaging device, CT-imaging device, conventional X-ray imaging device, etc.

FIG. 2 illustrates the method according to the invention in a schematic way. The step 202 is an initialization step in which the images are received. For example, a CT thorax study is received. This is a 3D volumetric image set which consists of slices of 2D images. The lung parenchyma are segmented from this volumetric image set by using for example a method as described in T. Bülow, R. Wiemker, T. Blaffert, C. Lorenz, S. Renisch, Automatic Extraction of the Pulmonary Artery Tree from Multi-Slice CT Data, SPIE, 5746:730-740, 2005. This results in a, so called, binary volumetric dataset wherein voxels that contribute to the parenchyma have a value equal to 1 and voxels that do not contribute to the parenchyma have a value equal to 0. This is schematically visualized in FIG. 3 as a stack 302 of 2 D slices 304, 306, 208, 310, and 312.

Within the next step 204, the segmentation boundaries in the x-and y dimension (xₘᵢₙ, xₘₐₓ, yₘᵢₙ, yₘₐₓ) that contain all parenchyma, i.e. voxels with value of 1, are determined from the binary volumetric dataset. This is also called the bounding box in x and y.

To set a Field of View (FOV) for either the left or the right lung, the binary volumetric dataset is processed to determine a separation position in between both lungs. To determine this separation position xₛ, a lung profile is reconstructed by first going over the binary volumetric dataset in x-direction and second, for every x-position taking each corresponding yz-slice and counting the number of segmented voxels, i.e. voxels with value of 1 in this slice. The result is a graph as illustrated in FIG. 4, which gives a histogram of the number of segmented voxels as a function of the x-position in the binary volumetric dataset. This histogram gives the profile p, 402. The separation position xₛ is determined between the two peaks, wherein each peak corresponds to one of the lungs. Computation of the separation position xₛ from the peaks is done in step 206. Here, the profile p is smoothed with an averaging filter defined as

$${p}_{smooth} ( x ) = \frac{1}{n} {\sum }_{x - n / 2}^{x + n / 2} p ( n )$$

Here n is the size of the averaging filter. Next, the linear derivative of the profile is computed by

$$\frac{d {p}_{smooth} ( x )}{d x} = {p}_{smooth} ( x ) - {p}_{smooth} ( x - 1 )$$

From the derivative of the profile all zero crossings are determined zc which are all points which satisfy the condition

$$zc ∈ ( \frac{d {p}_{smooth} ( x )}{d x} = 0 ⋁ ( \frac{d {p}_{smooth} ( x )}{d x} > 0 ⋀ \frac{d {p}_{smooth} ( x )}{d x} < 0 ) )$$

Last, the most central zero crossing zc is accepted as the separation position xₛ, 404.

The same technique can also be applied in 2D. This means the parameters (xₘᵢₙ, xₘₐₓ, xₛ, yₘᵢₙ, yₘₐₓ) are computed for each separate slice. For a given segmentation slice 304 (xₘᵢₙ, xₘₐₓ, yₘᵢₙ, yₘₐₓ) are computed taking the segmentation boundary in x and y. The profile is generated by counting the number of voxels in y-direction for each x. After this, the same separation position xₛ computation can be applied as in the 3D case.

Within step 208, the computation of the (x, y) pan position and (x, y) zoom factor starts for each slice from the resulting separation position xₛ. Given computed values (either from 3D or 2D) of (x_{min , x}ₘₐₓ, xₛ, yₘᵢₙ, yₘₐₓ) for a given slice a pan and zoom factor is computed to fit the parenchyma in a display with size (Lₓ, L_{y}). This is illustrated in FIG. 5 and is computed in the following way: first the origin for each factor is computed. For both parenchyma the origin is set to:

$${origin}_{both} = \{ \frac{( {y}_{max} + {y}_{min} )}{2} , \frac{( {x}_{max} + {x}_{min} )}{2} \}$$

For the left parenchyma the origin is set to:

$${origin}_{left} = \{ \frac{( {y}_{max} + {y}_{min} )}{2} , \frac{( {x}_{min} + {x}_{s} )}{2} \}$$

For the right parenchyma the origin is set to:

$${origin}_{right} = \{ \frac{( {y}_{max} + {y}_{min} )}{2} , \frac{( {x}_{max} + {x}_{s} )}{2} \}$$

After setting the origin, the object dimensions must be computed oₓ and o_{y} to the extent of the displayed area in order to zoom as much as possible while displaying the entire object. For the three separate cases the object dimension in x is defined as follows:

for both parenchyma as

o_{x,both}=xₘₐₓ−xₘᵢₙ

for the left parenchyma as

o_{x,left}=xₛ−xₘᵢₙ

and for the right parenchyma as

o_{x,right}=xₘₐₓ−xₛ

The object size in y is defined as

o_{y}=yₘₐₓ−yₘᵢₙ

The translation scheme from object size to display extent must cope with the aspect ratio of the display as follows. Further, within step 208 it is checked if Lₓ=L_{y}?

If the display sizes in x and y direction are equal to each other, then the Extends are computed in step 210 by setting the Extend in the x direction equal to the Extend in the y direction which is equal to the maximum of the origin in the x direction and the origin in the y direction:

Extendₓ=Extend_{y}=max(oₓ, o_{y})

Within step 212 it is checked if the Extend in the x direction is larger then the Extend in the y direction, i.e. Lₓ>L_{y}? If this is true, then within step 214 it is checked if the origin in the x direction is larger then the origin in the y direction, i.e. oₓ>o_{y}? If this is true, then within step 216 it is checked if the origin in the x direction is larger then the display size in the x direction, i.e. oₓ>Lₓ? If this is true then the Extends are computed in step 218 by setting the Extend in the x direction equal to the origin in the x direction and setting the Extend in the y direction equal to the Display Size in the y direction divided by the multiplication of the Display Size in the x direction and the origin in the x direction:

Extendₓ=oₓ

Extend_{y}=L_{y}/Lₓoₓ.

If step 216 or step 214 evaluate to false, then the Extends are computed in step 220 by setting the Extend in the x direction equal to the division of the Display Size in the x direction by the Display Size in the y direction and multiplying the result by the origin in the y direction. The Extend in the y direction is then equal to the origin in the y direction:

Extendₓ=(Lₓ/ L_{y})o_{y}

Extend_{y}=o_{y}.

If step 212 evaluates to false, then the Extend in the x direction is smaller then the Extend in the y direction, i.e. Lₓ<L_{y}. Then in step 222 it is checked if the origin in the x direction is larger then the origin in the y direction, i.e. oₓ>o_{y}? If this is true then step 218 is performed. If step 222 evaluates to false, then it is checked in step 224 if the origin in the y direction is larger then the Display Size in the y direction, i.e. o_{y}>L_{y}?. If this is true then step 220 is performed. If step 224 evaluates to false, then step 218 is performed. The Extends determine the zoom factor and the origin determines the pan position and the method ends in step 226 in which the slices are shown accordingly.

This way the zoom factor and pan position are calculated for each slice. Now when a user wants to navigate through the set of slices, each slice is zoomed and panned automatically which enables fast reading of the study.

The invention is not limited to the described example. It can for example also be applied to a Breast MR dataset as illustrated in FIG. 6. FIG. 6 illustrates for instance the profile 606 and separation position 608 as obtained for a Breast MR dataset 602 and 604. Given a binary volume with a segmentation of each breast, the invention can be applied. Advantageously a reduction in the user interaction that is required for standard viewing of datasets containing symmetric anatomical structures is achieved. Also, when using this method according to the invention the interaction time is reduced. Not only is the zoom factor and pan position set correctly for the visible slice, but also for the non-visible slices. The only interaction left is scrolling through the axial slices after the FOV is set to either a view on one or both lungs. Although some computational cost is needed to determine the FOV's, this does not negatively influence the user workflow, since all FOV's can be pre-computed at the moment the data is imported into a database.

An example of a received data set prior to the application of the invention is illustrated in FIG. 7a. FIG. 7b illustrates the resulting 3D-based FOV for both lungs. FIG. 7c illustrates the resulting FOV for the right lung and FIG. 7d illustrates the resulting FOV for the left lung. As is illustrated in FIGS. 7b to 7d, the FOV is set such that the lungs are covering the whole display area.

The method is applicable to all anatomies which can be represented by two binary objects after segmentation.

The proposed method can be implemented using buttons to set the FOV to one of the three presets. An example user interface 800 is given in FIG. 8. Using button icons 802, 804, and 806, which graphically describe their purpose a user can easily switch between all three FOV's without any complicated viewer interaction. For example: pressing icon 802 will display a FOV covering both lungs in field 808. Pressing icon 804 will display a FOV covering the left lung and pressing icon 806 will display a FOV covering the right lung. FIG. 9 illustrates a system according to the invention in a schematic way. The system 900 comprises a memory 902 that comprises computer readable software designed to perform the method according to the invention. The system 900 further comprises a central processing unit (cpu) 904 that is operatively connected to the memory 902 through software bus 906. The cpu 1004 performs the necessary calculations for executing the method according to the invention. The result is passed to display buffer 1008 which is operatively connected to display device 910. The data on which the method according to the invention is performed is retrieved from database 912 which is connected to a medical acquisition device 914 such as a CT scanner. The data that is acquired by the CT-scanner 914 from a person to be examined is sent to the database 912. The method according to the invention may be invoked during this import or for example by user interaction through display 910.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. A method for displaying within a display area (910) a symmetric anatomical structure (102, 104, 106, 108) the method comprising:
automatically calculating a zoom-factor (210, 218, 220) for the symmetric anatomical structure based upon the display area;
automatically calculating a panning position (206) for the symmetric anatomical structure based upon the display area;
displaying the symmetrical anatomical structure (102, 104, 106, 108) according to the calculated zoom-factor and panning position within the display area (910).

2. A method according to claim 1, wherein the symmetric anatomical structure is comprised within a 3D volumetric dataset comprising a stack of slices (302, 304, 306, 208, 310) and the method comprises automatically calculating the zoom-factor and the panning position for each slice of the stack of slices.

3. A method according to claim 1, wherein the symmetric anatomical structure comprises at least two sub-structures that are substantially symmetrical to each other and the method comprises:
automatically calculating the zoom-factor and the panning position for each at least two sub-structures separately; and
displaying the at least two sub-structures separately according to their respective calculated zoom-factor and panning position.

4. A method according to claim 1 wherein the zoom-factor and the panning position are automatically calculated during import of the symmetric anatomical structure within a database (912).

5. A method according to claim 1, wherein displaying the symmetric anatomical structure and/or sub-structures is automatically invoked through a user interface (800).

6. A system (900) for displaying within a display area (910) a symmetric anatomical structure (102, 104, 106, 108) the system comprising:
a calculator (902) for
automatically calculating a zoom-factor for the symmetric anatomical structure based upon the display area; and for
automatically calculating a panning position for the symmetric anatomical structure based upon the display area;
a displayer (902) for displaying the symmetrical anatomical structure according to the calculated zoom-factor and panning position within the display area.

7. A system according to claim 6, wherein the symmetric anatomical structure is comprised within a 3D volumetric dataset comprising a stack of slices (302, 304, 306, 208, 310) and the calculator is further for automatically calculating the zoom-factor and the panning position for each slice of the stack of slices.

8. A system according to claim 6, wherein the symmetric anatomical structure comprises at least two sub-structures that are substantially symmetrical to each other and the calculator is further for automatically calculating the zoom-factor and the panning position for each at least two sub-structures separately; and the displayer is further for displaying the at least two sub-structures separately according to their respective calculated zoom-factor and palming position.

9. A system according to claim 6 further comprising an importer (902) for automatically calculating the zoom-factor and the panning position during import of the symmetric anatomical structure within a database.

10. A system according to claim 6, further comprising a user interface (800) for automatically invoking displaying the symmetric anatomical structure and/or sub-structures.

11. A medical imaging workstation comprising the system according to claim 6.

12. A computer program product to be loaded by a computer arrangement, comprising instructions for displaying a symmetric anatomical structure within a display area, the computer arrangement comprising processing unit and a memory, the computer program product, being executable by a processing unit to carry out the following tasks:
automatically calculating a zoom-factor for the symmetric anatomical structure based upon the display area;
automatically calculating a panning position for the symmetric anatomical structure based upon the display area;
displaying the symmetrical anatomical structure according to the calculated zoom-factor and panning position within the display area.
